(19) United States
(12) Patent Application Publication
(10) Pub. No.: US 2013/0192142 A1
(43) Pub. Date: Aug. 1, 2013

(54) SEALING DEVICE

(71) Applicant: GM GLOBAL TECHNOLOGY OPERATIONS LLC, Detroit, MI (US)

(72) Inventor: Sebastian WENDE, Harxheim (DE)

(73) Assignee: GM GLOBAL TECHNOLOGY OPERATIONS LLC, Detroit, MI (US)

(21) Appl. No.: 13/741,570

(22) Filed: Jan. 15, 2013

(30) Foreign Application Priority Data
Jan. 16, 2012 (DE) 102012000703.5

(51) Int. Cl. B60J 10/04; B60J 10/02

(52) U.S. Cl. CPC B60J 10/04; B60J 10/02
USPC 49/475.1

(57) ABSTRACT

A sealing device for a shaft structure of a frame device for a wall element of a motor vehicle is provided. The sealing device includes a thermoplastic bearing element secured or configured to be secured on the shaft structure of the motor vehicle. A sealing means is configured to be at least partially arranged or is at least partially arranged on the wall element and is secured or is configured to be secured on the thermoplastic bearing element. A shape-stabilizing means is configured to counteract a temperature-dependent change in a shape of the thermoplastic bearing means and/or the sealing means. A frame device and a motor vehicle having the sealing device are also provided.

### CROSS-REFERENCE TO RELATED APPLICATION

This Application claims priority to German Patent Application No. 102012000703.5, filed Jan. 16, 2012, which is incorporated herein by reference in its entirety.

### TECHNICAL FIELD

The technical field relates to a sealing device for a shaft structure of a frame device, wherein in the frame device a translucent and/or transparent wall element, such as a vehicle window, can be arranged or is arranged to a frame device having such a sealing device and to a motor vehicle having such a frame device and/or having such a sealing device.

### BACKGROUND

Sealing devices for transparent and/or translucent wall elements of a motor vehicle are known. These surround the wall elements designed as vehicle windows in the region of a window shaft strip of the frame device of the motor vehicle at least in sections and seal the shaft structure among other things against an entering of noise, dust, wind and/or moisture towards the inside.

With the known sealing devices, the sealing means contacting the window pane is arranged on a support element of metal. With the latter, this sealing means can be fixed on the vehicle structure of the motor vehicle. In addition, the metallic support element prevents an excessive expanding or contracting of the sealing element during temperature fluctuations.

In addition to this, sealing devices are known wherein the support element is formed of a thermoplastic. Here it has proved to be disadvantageous that the sealing device expands at high temperatures such that recesses have to be provided in the vehicle structure into which the sealing device can expand.

At least one object herein is to provide a sealing device with which a temperature-dependent change in shape is reduced. In addition, other objects, desirable features and characteristics will become apparent from the subsequent summary and detailed description, and the appended claims, taken in conjunction with the accompanying drawings and this background.

### SUMMARY

In an exemplary embodiment, a sealing device for a shaft structure of a frame device is provided. In the frame device a transparent and/or translucent wall element, such as a vehicle window, can be arranged or is arranged with a sealing means that can be arranged or is arranged on the wall element at least in sections. At least one at least partially thermoplastic support element can be fixed or is fixed on a shaft structure of the motor vehicle, to which the sealing means can be fixed or is fixed. At least one shape stabilizing means counteracts a temperature-dependent change in shape of the thermoplastic support element and/or of the sealing means.

The frame device can comprise a vehicle door or vehicle wall.

In an embodiment, the shape stabilizing means is substantially dimensionally stable independently of temperature. Substantially dimensionally stable independently of temperature is to mean that the shape stabilizing means, at an ambient temperature at which the motor vehicle is generally operated (approx. −50° C. to 70° C.), does not substantially change its length and/or width extension. In one embodiment, the sealing device can be a window shaft guide seal of a motor vehicle, which is arranged on a window shaft strip of the motor vehicle. In such a case, the sealing device can be merely arranged on a side wall of the shaft structure or be arranged on two side walls of the shaft structure located opposite each other.

In that a shape stabilizing means is provided, which counteracts a temperature-dependent change in shape of the sealing means and/or of the support element, the support element can be formed of a thermoplastic. In contrast with the known sealing devices, the use of support elements of metal can be omitted in such a case, as a result of which manufacturing costs are reduced and the weight of the sealing device is reduced.

Moreover, the providing of recesses in the vehicle structure for receiving the expanding support element and/or the expanding sealing means at high temperatures can be omitted, as a result of which a more efficient design of the motor vehicle can be achieved.

The shape stabilizing means can be fixed or is fixed in or on the thermoplastic support element and/or in or on the sealing means.

In principle, the support element and/or the sealing means can comprise any plastic. However, in one embodiment, the support element comprises polypropylene and the sealing means comprises at least one vulcanized thermoplastic.

Moreover, the shape stabilizing means can comprise any shape and any material which is substantially dimensionally stable independently of temperature in the manner described above.

In an exemplary embodiment, the shape stabilizing means comprises at least one glass fiber element and/or at least one metal part.

Furthermore, the sealing device can comprise a plurality of shape stabilizing means, wherein a shape stabilizing means can comprise a glass fiber element and a further shape stabilizing means a metal part. Moreover, it is conceivable that all shape stabilizing means comprise metal parts or that all shape stabilizing means comprise glass fiber elements.

If the shape stabilizing means comprises a metal part, in an embodiment, the shape stabilizing means is configured strip- or plate-like, in particular comprises a U-shaped cross section, and/or comprises stainless steel and/or aluminum, for example, a bent sheet metal part.

In such a case, the shape stabilizing means can be produced simply and cost-effectively.

If the shape stabilizing means comprises a glass fiber element, in an embodiment the at least one glass fiber element has a diameter in the range of from about 0.1 mm and to about 1.0 mm, preferably from about 0.3 mm to about 0.8 mm, for example about 0.5 mm.

Because of this, a high stability with compact design of the shape stabilizing means can be achieved. The sealing device can be merely arranged on a side wall of the shaft structure or on two side walls of the shaft structure located opposite each other. In such a case, the sealing means can bear against a surface of the wall element facing the vehicle interior and/or facing away from the vehicle interior.

In principle it is conceivable that the wall element is fixed against a movement. In such a case it is conceivable that the wall element is fixed in the frame device of the motor vehicle in such a manner that it projects through the sealing device in the direction of a vehicle floor plane.

It is conceivable, moreover, that the wall element transversely or obliquely to a vehicle floor plane bearing against the sealing means can be slidingly moved along.

As a further development of the last mentioned inventive idea, the wall element can protrude over the frame device at least in a closed function position—seen transversely to the vehicle plane.

In an exemplary embodiment, the sealing device can form a lateral guide for the wall element.

If the sealing device is arranged on a shaft structure of the frame device of the motor vehicle, in an embodiment, the sealing device extends strip-like, for example, linearly, and/or if the at least one shape stabilizing means at least in sections extends along the extension of the sealing device, for example, in a parallel manner.

The support element can be arranged on a side wall of the shaft structure in any way. It is conceivable, for example, that the support element is glued on, screwed on or welded on. However, in an exemplary embodiment, the support element comprises a U-shaped coupling section comprising at least two parallel sections and at least one transverse section, with which the support element can be fixed or is fixed on a side wall of the side structure of the frame device, for example, parallel to the movement direction of the wall element, through sliding on.

In such a case, the assembly of the sealing device is simplified.

In another exemplary embodiment, the support element comprises one or more of a surface of a parallel section facing the side wall, at least one protrusion which extends in the direction of the side wall of the shaft structure.

In such a case, the protrusion runs transversely or obliquely to the parallel section of the coupling section of the support element.

With an embodiment of the frame device, at least one protrusion is provided on each of the parallel sections. With a further exemplary embodiment, three protrusions are provided on each parallel section, each of which runs parallel to one another.

Moreover, in an embodiment, the sealing means comprises one or more sealing body(s) arranged on a parallel section of the mounting of the support element, with which it bears against the wall element and/or if at least one sealing body extends transversely or obliquely away from the parallel section in the direction of the wall element.

In that the sealing means comprises a sealing body, which extends away in the direction of the wall element, the sealing action of the sealing means is improved. In addition, the sealing body can be displaced through the wall element in the direction of the support element in a flexibly pliable manner.

The shape stabilizing means can, in principle, be arranged at any point of the sealing device. In such a case it is conceivable, for example, that the shape stabilizing means is at least in sections arranged between the sealing means and the support element and/or if the shape stabilizing means is arranged at least in sections in the parallel section of the mounting of the support element, on which the sealing body is arranged.

In such a case, the shape stabilizing means is arranged in the middle of the sealing device, as a result of which a counteracting against a change in shape is improved. In such a case, the sealing means can also be easily designed thermoplastically.

It is conceivable that the shape stabilizing means following the creation of the support element and/or of the sealing means is introduced into this or into both. It proves to be practical under production aspects, however, if the shape stabilizing means, the thermoplastic support element and/or the sealing means comprise a common co-extruded component.

In a further embodiment, a frame device has a sealing device with at least one of the features mentioned above.

In another embodiment, a motor vehicle has a frame device of the previously mentioned features or with a sealing device with at least one of the previously mentioned features.

The inventive sealing device, the inventive frame device and the inventive motor vehicle overcome the prior art in multiple respects:

In that a shape stabilizing means is provided, a thermoplastic can be made use of for the support element. Because of this, the manufacturing costs and the weight of the sealing device are reduced.

The manufacturing costs are moreover further reduced if the sealing device comprises a component that is created through co-extruding the shape stabilizing means with the thermoplastic support element and the sealing means.

Further features, details and advantages are obtained from the attached patent claims from the drawing representation and the following description of preferred embodiments of the sealing device as described herein.

### BRIEF DESCRIPTION OF THE DRAWINGS

The various embodiments will hereinafter be described in conjunction with the following drawing figures, wherein like numerals denote like elements, and wherein:

FIG. 1 is a schematic perspective view of a sealing device with shape stabilizing means in accordance with an exemplary embodiment;

FIG. 2 is a schematic perspective view of a sealing device with shape stabilizing means in accordance with another exemplary embodiment; and

FIG. 3 is a schematic perspective view of a sealing device with shape stabilizing means in accordance with a further exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

The Figs. show a sealing device for a shaft structure of a frame device of a motor vehicle altogether provided with the reference number 2. In the frame device, a transparent and/or translucent wall element can be arranged. In an exemplary embodiment, the wall element is a vehicle window of a motor vehicle.

The sealing device 2 comprises a sealing means 4, which at least in sections can be arranged or is arranged on the wall element. With the exemplary embodiment shown in the Figures, the sealing means 4 each comprises two sealing bodies 6, which extend in the direction towards the wall element (not shown in the Figures). The sealing means 4 is fixed on a thermoplastic support element 8, which in turn can be fixed on a shaft structure, in particular a side wall of the shaft structure.

Both the support element 8 as well as the sealing means 4 are formed from plastic and are temperature-dependent in their shape. Thus, the support element 8 can comprise polypropylene and the sealing means 4 a vulcanized thermoplastic.

In order to counteract the temperature-dependent change in shape of the support element 8 and/or of the sealing means 4, the sealing device 2 comprises a shape stabilizing means 10.

With the exemplary embodiments shown in the Figures, the shape stabilizing means 10 is fixed in or on the thermoplastic support element 8 through co-extruding.

In order to fix the sealing device 2 to the vehicle structure, in particular to a side wall of the shaft structure of the frame device, the thermoplastic support element 8 comprises a coupling section 12, which is configured U-shaped in an exemplary embodiment.

The U-shape is formed through two parallel sections 14 and a transverse section 16. On the surface of the parallel sections 14 facing the shaft structure, the coupling section 12 of the support element 8 comprises protrusions 18, each of which extend in the direction of the shaft structure, in particular of the side wall of the shaft structure. In order to increase the sealing effect or the contact force with which the support element 8 bears against the shaft structure, the protrusions 18 are extended in the direction of the shaft structure.

Moreover, all exemplary embodiments visible in the Figures have in common that the sealing bodies 6 are arranged on the parallel section 14 of the coupling section 12 of the support element 8 facing the wall element. From this parallel section 14 facing the wall element, the sealing bodies 6 substantially extend away transversely or obliquely.

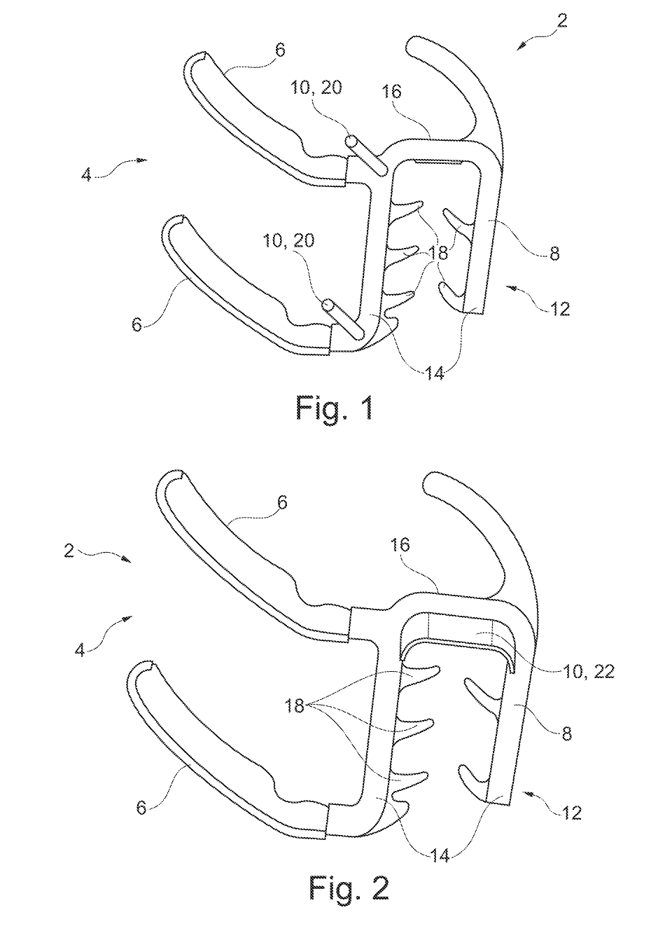

FIG. 1 shows a first exemplary embodiment of the sealing device 2, with which two shape stabilizing means 10 are provided, which are formed through glass fiber elements 20. The glass fiber elements 20 substantially run in extension direction of the sealing device 2. With the exemplary embodiment shown in FIG. 2, the shape stabilizing means 10 designed as glass fiber elements 20 are arranged in the parallel section 14 of the coupling section 12 of the support element 8 facing the wall element. Because of this, the shape stabilizing means 10 is substantially arranged in the middle of the sealing device 2.

FIG. 2 shows a second exemplary embodiment of the sealing device 2 with which the shape stabilizing means 10 is formed through a plate-shaped metal part 22 having a U-shaped cross section. In the exemplary embodiment shown in FIG. 2, the shape stabilizing means 10 is arranged in the transverse section 16 of the coupling section 12 of the support element 8. In such a case, it engages, at least partially, about the shaft structure of the motor vehicle. With the exemplary embodiment shown in FIG. 2, the shape stabilizing means 10, too, substantially extends in the extension direction of the sealing device 2.

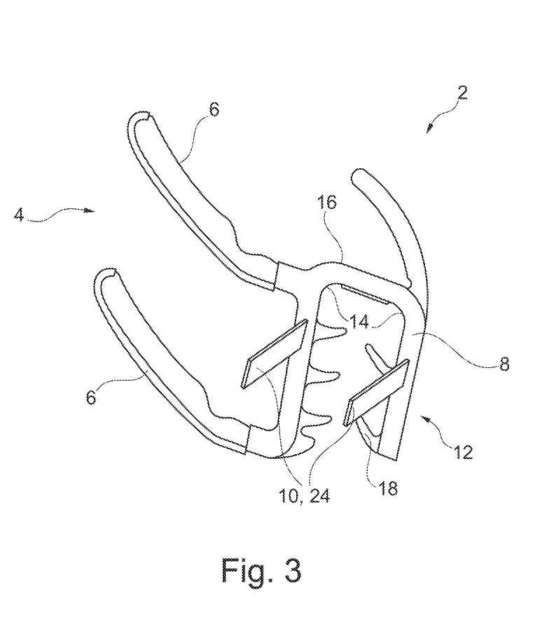

FIG. 3 shows a third exemplary embodiment of the sealing device 2 with which two shape stabilizing means 10 are provided, which are configured as strip-shaped metal parts 24. With the exemplary embodiment that is evident in FIG. 3, at least one shape stabilizing means 10 designed as strip-shaped metal part 24 is arranged in each of the two parallel sections 14, wherein the strip-shaped metal parts 24 extend in the extension direction of the sealing device 2.

The features disclosed in the above description, in the claims, and in the drawing can be substantial both individually, as well as in any combination in realizing the various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A sealing device for a shaft structure of a frame device for a wall element of a motor vehicle, the sealing device comprising:
a thermoplastic bearing element secured or configured to be secured on the shaft structure of the motor vehicle;
a sealing means configured to be at least partially arranged or at least partially arranged on the wall element and secured or configured to be secured on the thermoplastic bearing element;
a shape-stabilizing means configured to counteract a temperature-dependent change in a shape of the thermoplastic bearing element and/or the sealing means.

2. The sealing device according to claim 1, wherein the wall element is transparent and/or translucent.

3. The sealing device according to claim 2, wherein the wall element is a vehicle window.

4. The sealing device according to claim 1, wherein the shape-stabilizing means is secured or is configured to be secured in or on the thermoplastic bearing element and/or in or on the sealing means.

5. The sealing device according to claim 1, wherein the thermoplastic bearing element comprises polypropylene and the sealing means comprises vulcanized thermoplast.

6. The sealing device according to claim 1, wherein the shape-stabilizing means comprises a glass fiber element and/or a metal part.

7. The sealing device according to claim 6, wherein the shape-stabilizing means has a strip shape or a plate shape.

8. The sealing device according to claim 7, wherein the shape-stabilizing means has a U-shaped cross-section.

9. The sealing device according to claim 6, wherein the shape-stabilizing means comprises stainless steel and/or aluminum.

10. The sealing device according to claim 6, wherein the shape-stabilizing means is a bent sheet metal part.

11. The sealing device according to claim 6, wherein the glass fiber element comprises a diameter in a range of from about 0.1 to about 1.0.

12. The sealing device according to claim 1, wherein the sealing means lies against a surface of the wall element facing an interior of the motor vehicle and/or wherein the sealing means lies against the surface of the wall element facing away from the interior of the motor vehicle.

13. The sealing device according to claim 1, wherein the wall element is movable with respect to a plane of a vehicle floor, sliding along lying adjacent to the sealing means, and/or wherein the wall element projects over the sealing device at least in a closed functional position viewed transversely to the plane.

14. The sealing device according to claim 1, wherein the sealing device extends in a manner of a strip and/or wherein the shape-stabilizing means is extended at least partially along, in particular parallel to, the extent of the sealing device.

15. The sealing device according to claim 1, wherein the thermoplastic bearing element comprises a U-shaped coupling section having at least two parallel sections and at least one transverse section, by which the thermoplastic bearing element is secured or is configured to be secured slidably onto a side wall of the shaft structure of the frame device.

16. The sealing device according to claim 1, wherein the sealing means comprises a sealing body arranged on a parallel section of a mount of the thermoplastic bearing element, by which it lies against the wall element and/or wherein the sealing body extends away transversely or obliquely from the parallel section in a direction of the wall element.

17. The sealing device according to claim 16, wherein the shape-stabilizing means is arranged at least partially between the sealing means and the thermoplastic bearing element and/or wherein the shape-stabilizing means is arranged at least partially in the parallel section of the mount of the thermoplastic bearing element, on which the sealing body is arranged.

18. The sealing device according to claim 1, wherein the shape-stabilizing means, the thermoplastic bearing element, and/or the sealing means comprises a jointly coextruded component.

19. A frame device for a wall element of a motor vehicle, the frame device having a sealing device for a shaft structure of the frame device, the sealing device comprising:
a thermoplastic bearing element secured or configured to be secured on the shaft structure of the motor vehicle;
a sealing means configured to be at least partially arranged or at least partially arranged on the wall element and secured or configured to be secured on the thermoplastic bearing element;
a shape-stabilizing means configured to counteract a temperature-dependent change in a shape of the thermoplastic bearing element and/or the sealing means.

20. A motor vehicle having a frame device for a wall element, the frame device having a sealing device for a shaft structure of the frame device, the sealing device comprising:
a thermoplastic bearing element secured or configured to be secured on the shaft structure of the motor vehicle;
a sealing means configured to be at least partially arranged or at least partially arranged on the wall element and secured or configured to be secured on the thermoplastic bearing element;
a shape-stabilizing means configured to counteract a temperature-dependent change in a shape of the thermoplastic bearing element and/or the sealing means.
